(19) United States
(12) Patent Application Publication
(10) Pub. No.: US 2005/0091820 A1
(43) Pub. Date: May 5, 2005

(54) Using infrared rays for quick joining a golf club head

(76) Inventors: Shyi-Kaan Wu, Taipei (TW); Ren-Kae Shiue, Hualien Hsien (TW); Chan-Tung Chen, Kaohsiung (TW)

Correspondence Address: BIRCH STEWART KOLASCH & BIRCH, PO BOX 747, FALLS CHURCH, VA, 22040-0747, US

(21) Appl. No.: 10/695,751

(22) Filed: Oct. 30, 2003

(51) Int. Cl. B23Q 17/00; G01M 19/00

(52) U.S. Cl. 29/428

(57) ABSTRACT

Using infrared rays for quick joining a golf club head adopts a heating source of infrared rays, which are used to melt metallic fillers disposed between a main head body and a striking plate. Thus, the striking plate is bonded to the main head body to constitute the golf club head.

### BACKGROUND OF THE INVENTION

1. Field of the Invention

The present invention is related to using infrared rays for quick joining a golf club head. More particularly, the present invention is related to using infrared rays for heating the filler metal which is filled between a main head body and a striking plate to manufacture the golf club head.

2. Description of the Related Art

The infrared ray has a frequency in the electromagnetic spectrum in the range just below that of red light. A quartz tube can radiate infrared rays in proportion to their temperature. The infrared ray is used to join separate objects within a small bonding area. Infrared joining can carry out rapid heating and cooling on the object.

A conventional golf club head is consisted of a golf club head and a striking plate combined therewith. The joining method of the golf club head can be selected from a group of mechanically inserted method, glued method, welding method and brazing method etc. The welding method is unsuitable for the golf club head if the golf club head and the striking plate are made of dissimilar categories of alloy that results in a poor welding joint. Accordingly, the mechanically inserted method, the glued method and brazing method are available for the golf club head. As to the brazing method, there is a need for metallic filler disposed between the golf club head and the striking plate. Then the golf club head and the striking plate are heated in a furnace so that the heating metallic filler is melted to closely fill in a gap formed between the golf club head and the striking plate. After cooling, the striking plate is bonded to the golf club head.

The material of the main head body of the golf club head includes stainless steel, maraging steel, titanium alloy, aluminum alloy or magnesium alloy etc. And the material of the striking plate includes titanium alloy, maraging steel, shape memory steel, bulk amorphous alloy etc. Generally, the golf club head is made of stainless steel, such as 17-4PH, and the striking plate is made of titanium alloy, such as Ti-6Al-4V. In joining process, if the conventional brazed method is employed, heating speed of the golf club head is low (about 5-50 degrees centigrade per minute). In order to avoid detrimental effects caused by exposing members of the golf club head to the high-temperature conditions over a long time, the brazing temperature ranges approximately between 0 and 50 degrees centigrade over the melting points of metallic filler for 10 to 30 minutes. Accordingly, the liquid state of the metallic filler can wet the members (base metal) of the golf club head for brazing them together. Both high temperature and/or long time exposure of the joint in conventional brazing may generally result in dissolution of the joined substrates. That is, in high-temperature conditions, a part of the golf club head or striking plate may be blended into the metallic filler. This is so called alloying effect. Once the composition of the metallic filler is changed, it may affect fluidity and wettability of the metallic filler such that construction of the joint may be weakened. In addition, an intermetallic compound with brittleness is formed between the metallic filler and the base metal of the golf club head, or between the metallic filler and the base metal of the striking plate. If a thickness of the intermetallic compound is grown specifically thick, mechanical strength and impact-resistant of the joined portion is weakened. For this reason, the combination of dissimilar categories of alloys still mainly adopts mechanically inserted method and glued method.

Hence, there is a concern for overcoming the conventional brazing, and improving the joined performance of dissimilar categories of metals. To this end, generation of alloying affect and intermetallic compound should be avoided as far as possible to increase reliability of a joined portion. Obviously, a shortened processing time and a rapid heating process can overcome drawbacks of the conventional brazing.

The present invention intends to use infrared rays for quick joining a golf club head in such a way to mitigate and/or overcome the above problem.

### SUMMARY OF THE INVENTION

The primary objective of this invention is using infrared rays for quick joining a golf club head which employs geometrical optics device to focus and reflect infrared rays for increasing energy density and heating rate. According to design choice, the geometrical optics device is selected from ellipsoid and parabolic reflector whose rear surface is plated with gold and cooled by cooling water. Thereby, the geometrical optics device has a preferred reflecting effect and is suitable for high-temperature conditions. In order to increase power efficiency and to save power, infrared rays is penetrated through a quartz tube and focused on the joined area of golf club head members. Since infrared rays have a character of rapid heating and cooling, the process time of joining is significantly shortened. In comparison with convention heating rate (approximately 5-50 degrees centigrade/min), the heading rate of infrared rays for quick joining a golf club head is as high as 3000 degrees centigrade/min and it can avoid exposing members of the golf club head to the high-temperature conditions over a long time. Thereby, the members of the golf club head can avoid influences of high-temperature environments. In addition, the processing time is precisely controlled within a processing temperature controller so that the process temperature is unnecessary to limit ranging between 0 and 50 degrees centigrade over the melting point of the metallic filler. Regarding manufacture efficiency and automatic control, using infrared rays for joining is better than the conventional blazing.

Using infrared rays for quick joining in accordance with the present invention applies to a golf club head which consisted of a main head body and a striking plate. The main head body and the striking plate are made of different material. Metallic filler is disposed between the main head body and the striking plate. Infrared rays is used to melt the metallic filler to fill between the main head body and the striking plate, and thus the melted metallic filler is rapidly wetted and joined the main head body and the striking plate in a shortened time. The material of the main head body is selected from a group consisted of stainless steel, maraging steel, titanium alloy, aluminum alloy or magnesium alloy etc. And the material of the striking plate is selected from a group consisted of titanium alloy, maraging steel, shape memory steel, bulk amorphous alloy etc.

Other objectives, advantages and novel features of the invention will become more apparent from the following detailed description and the accompanying drawings.

### BRIEF DESCRIPTION OF THE DRAWINGS

The present invention will now be described in detail with reference to the accompanying drawings herein:

FIG. 1 is an exploded view of using infrared rays for quick joining a golf club head in accordance with a first embodiment of the present invention;

FIG. 2 is an exploded view of using infrared rays for quick joining a golf club head in accordance with a second embodiment of the present invention;

FIG. 3 is a symbol diagram of processing parameters of using infrared rays for quick joining a golf club head in accordance with the present invention;

FIG. 4a is an SEM photograph of using infrared rays for joining materials consisted of Ti-6Al-4V, Ag and 17-4PH at 1,000 degrees centigrade for 30 sec in accordance with the present invention;

FIG. 4b is an SEM photograph of using infrared rays for joining materials consisted of Ti-6Al-4V, Ag and 17-4PH at 1,000 degrees centigrade for 120 sec in accordance with the present invention;

FIG. 4c is an SEM photograph of using infrared rays for joining materials consisted of Ti-6Al-4V, Ag and 17-4PH at 1,000 degrees centigrade for 210 sec in accordance with the present invention;

FIG. 4d is an SEM photograph of using infrared rays for joining materials consisted of Ti-6Al-4V, Ag and 17-4PH at 1,000 degrees centigrade for 300 sec in accordance with the present invention;

FIG. 5 is an experimental data diagram of shearing test for a joint consisted of Ti-6Al-4V, Ag and 17-4PH in accordance with the present invention;

FIG. 6a is SEM photographs of using infrared rays for joined materials consisted of Ti-6Al-4V, 72Ag-28Cu and 17-4PH at 800 degrees centigrade for 120 sec in accordance with the present invention;

FIG. 6b is an EPMA data diagram of analyzing chemical composition of a joint consisted of Ti-6Al-4V, 72Ag-28Cu and 17-4PH at 800 degrees centigrade for 120 sec in accordance with the present invention;

FIG. 7a is an SEM photograph of using infrared rays for joining materials consisted of Ti-6Al-4V, 72Ag-28Cu and 17-4PH at 850 degrees centigrade for 30 sec in accordance with the present invention;

FIG. 7b is an SEM photograph of using infrared rays for joining materials consisted of Ti-6Al-4V, 72Ag-28Cu and 17-4PH at 850 degrees centigrade for 120 sec in accordance with the present invention;

FIG. 7c is an SEM photograph of using infrared rays for joining materials consisted of Ti-6Al-4V, 72Ag-28Cu and 17-4PH at 850 degrees centigrade for 300 sec in accordance with the present invention;

FIG. 8 is an experimental data diagram of shearing test for a joint consisted of Ti-6Al-4V, 72Ag-28Cu and 17-4PH in accordance with the present invention;

FIG. 9a is an SEM photograph of using infrared rays for joining materials consisted of Ti-6Al-4V, 95Ag-5Al and 17-4PH at 830 degrees centigrade for 300 sec in accordance with the present invention;

FIG. 9b is an SEM photograph of using infrared rays for joining materials consisted of Ti-6Al-4V, 95Ag-5Al and 17-4PH at 850 degrees centigrade for 120 sec in accordance with the present invention;

FIG. 9c is an SEM photograph of using infrared rays for joining materials consisted of Ti-6Al-4V, 95Ag-5Al and 17-4PH at 850 degrees centigrade for 300 sec in accordance with the present invention;

FIG. 9d is an SEM photograph of using infrared rays for joining materials consisted of Ti-6Al-4V, 95Ag-5Al and 17-4PH at 900 degrees centigrade for 120 sec in accordance with the present invention; and

FIG. 10 is an experimental data diagram of shearing test for a joint consisted of Ti-6Al-4V, 95Ag-5Al and 17-4PH in accordance with the present invention.

### DETAILED DESCRIPTION OF THE INVENTION

Using infrared rays for quick joining a golf club head the present invention adopts an infrared furnace of ULVAC SINKO-RIKO RHL-P610C. The infrared furnace has 6 quartz tubes (containing tungsten heating wire) and 6 parabolic reflectors, and can be operated up to 1,300 degrees centigrade. The infrared furnace is operated under argon gas or high vacuum less than 5*10⁻⁵ mbar. Preferably, the wavelength of infrared rays is ranging between 0.76 and 1,000 μm.

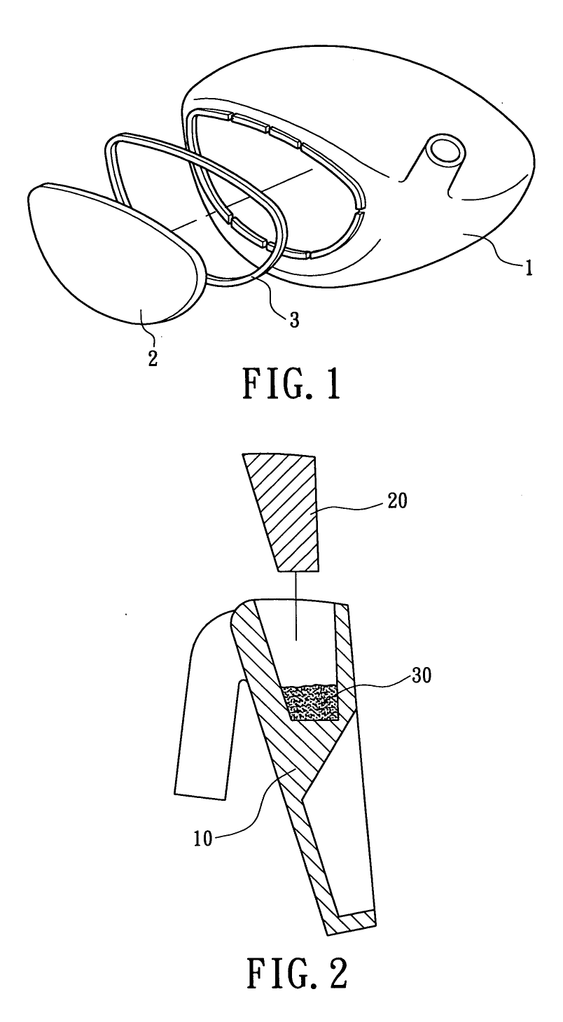

FIG. 1 illustrates an exploded view of using infrared rays for quick joining a golf club head in accordance with a first embodiment of the present invention. The golf club head is consisted of a plurality of parts, which includes a main head body 1, a striking plate 2 and a metallic filler member 3. Subsequent to the main head body 1 combing with the striking plate 2, the metallic filler member 3 is disposed between the main head body 1 and the striking plate 2. Subsequently, infrared rays are used to heat and melt the metallic filler member 3. After cooling, the metallic filler member 3 can connect the main head body 1 with the striking plate 2. In this embodiment, the main head body 1 is made of stainless steel and the striking plate is made of titanium alloy. The material of the main head body 1 is selected from 17-4PH stainless steel, which performs high strength, corrosive-resistance and good wettability. The material of the striking plate 2 is selected from Ti-6Al-4V alloy, which performs high strength, corrosive-resistance and good wettability. The material of the metallic filler member 3 is selected from a group consisted of Ag-base fillers of Ag, 72Ag-28Cu and 95Ag-5Al, Ni-base fillers, Cu-base fillers, or Ti-base fillers.

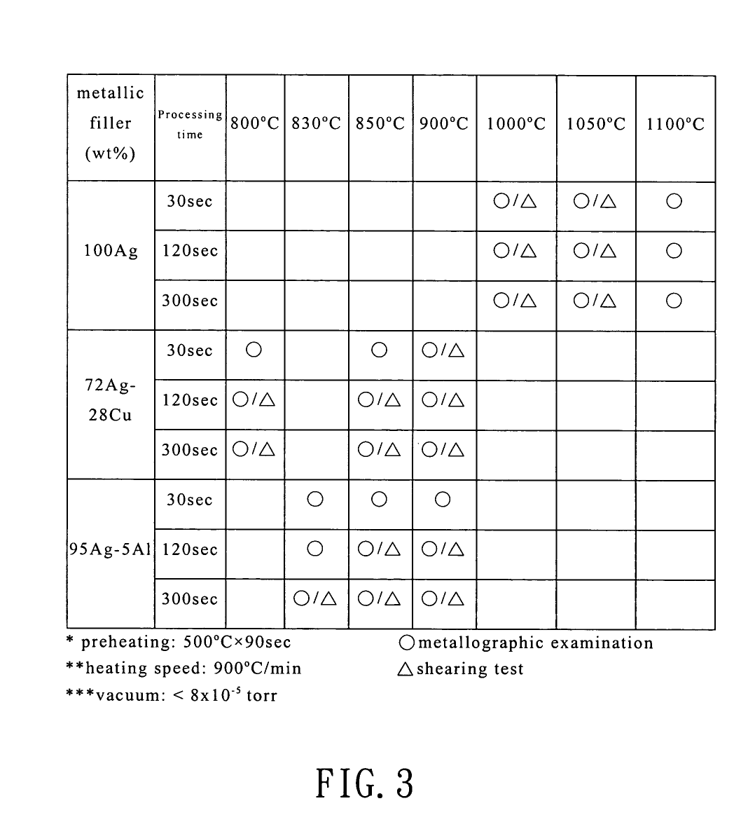

FIG. 2 illustrates an exploded view of using infrared rays for quick joining a golf club head in accordance with a second embodiment of the present invention. The golf club head includes a main head body 10, a weight member 20 and a metallic filler member 30. The material of the main head body 10 is selected from a group consisted of titanium alloy, Fe-base alloy, magnesium alloy, aluminum alloy, Fe—Mn—Al alloy, shape memory steel, tungsten alloy, copper alloy, nickel alloy, bulk amorphous alloy, nano-alloy, composite material and ceramic material etc. The specific gravity of the weight member 20 is greater than that of the main head body 10, and selected from a group consisted of tungsten, tungsten alloy, copper alloy and lead alloy etc. The material of the metallic filler member 30 is selected from a group consisted of Ag-base fillers, Ni-base fillers, Cu-base fillers, or Ti-base fillers. Subsequent to the main head body 10 combing with the weight member 20, the metallic filler member 30 is disposed between the main head body 10 and the weight member 20. Subsequently, infrared rays are used to heat and melt the metallic filler member 30. After cooling, the metallic filler member 30 can connect the main head body 10 with the weight member 20. In order to avoid alloying effect upon the main head body 10 and the weight member 20, the heating rate of the infrared furnace is not less than 1° C./sec, more preferably 50° C./sec. Regarding processing parameters of using infrared rays for joining, preheating temperature, heating rate, vacuum condition, processing temperature and time are described more detail in FIG. 3.

Using infrared rays for quick joining the golf club head is processed in atmosphere. In order to avoid oxidation of the metallic filler member 10 during the process, the golf club head is processed in vacuum or inert gas including nitrogen, argon and helium etc.

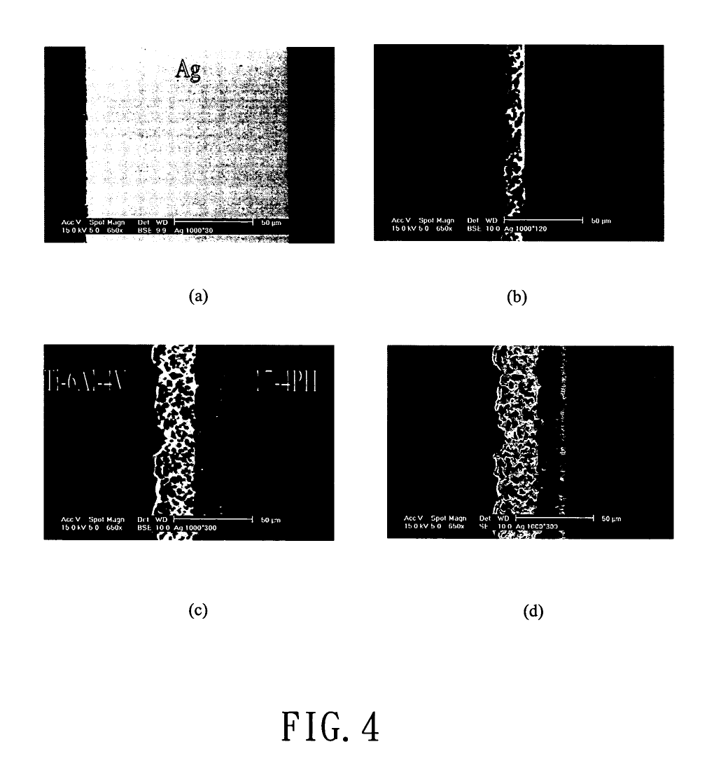

FIGS. 4a through 4d illustrate SEM (Scanning Electron Microscope) photographs of using infrared rays for a joint of Ti-6Al-4V, Ag and 17-4PH at 1,000 degrees centigrade for 30 sec. The alloying effect upon interfaces of the joint of Ti-6Al-4V, Ag and 17-4PH is obviously suppressed.

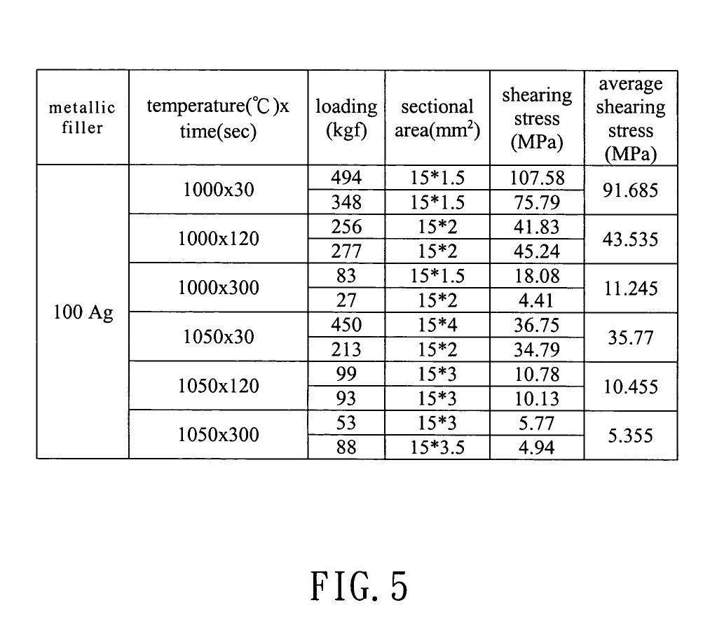

FIG. 5 illustrates an experimental data diagram of shearing test for a joint consisted of Ti-6Al-4V, Ag and 17-4PH. It appears that an excellently joined quality is carried out if the processing temperature is low or the processing time is short. The alloying effect between Ti-6Al-4V and Ag, or between Ag and 17-4PH steel is greatly decreased since it is using infrared rays for quick joining. The averaged shear strength of pure silver filler is as high as 91.7 MPa. In addition, a compact joint is accomplished by using infrared heating.

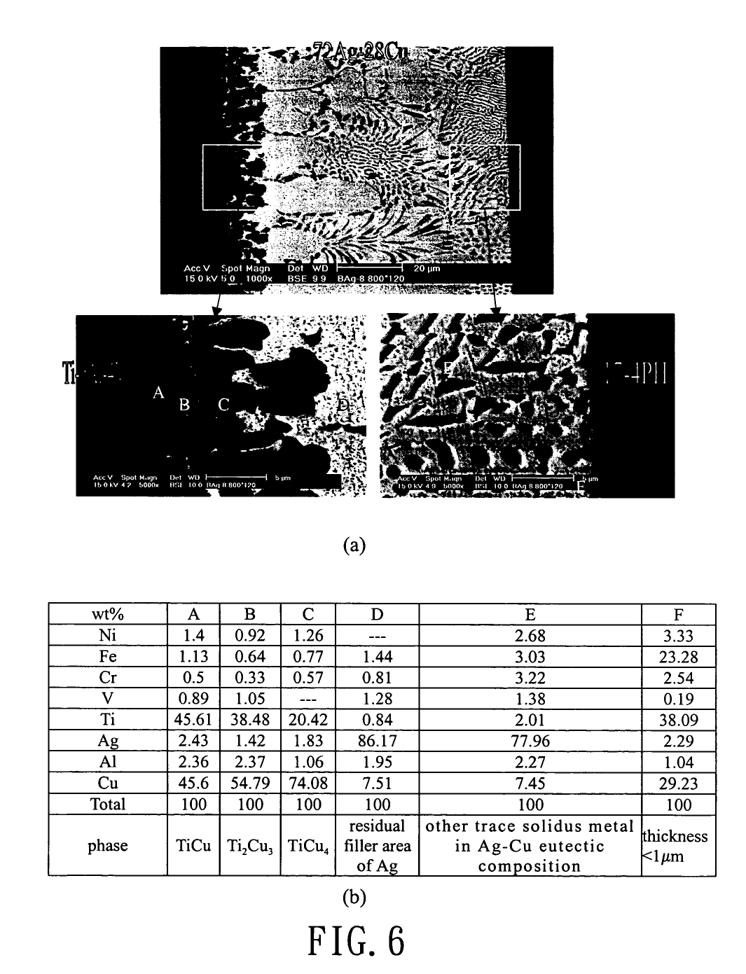

FIG. 6a illustrates SEM photographs of using infrared rays for joining materials consisted of Ti-6Al-4V, 72Ag-28Cu and 17-4PH at 800 degrees centigrade for 120 sec. FIG. 6b illustrates an EPMA (Electron Probe Microanalyzer) data diagram of analyzing chemical composition of the joint consisted of Ti-6Al-4V, 72Ag-28Cu and 17-4PH at 800 degrees centigrade for 120 sec. In FIG. 6a, the Ti—Cu compounds (TiCu, Ti₂Cu₃, TiCu₄) are observed at the interface between Ti-6Al-4V and the 72Ag-28Cu. It can also be found that Cu atoms of the metallic filler (72Ag-28Cu) react with Ti-6Al-4V but Ag atoms do not react with Ti-6Al-4V. Thus, there is a decrease of Cu content from the 72Ag-28Cu filler.

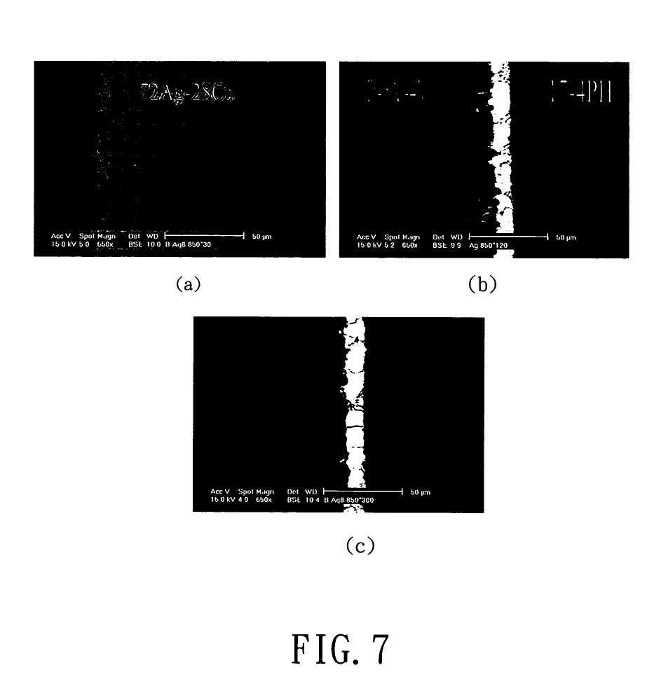

FIGS. 7a through 7c illustrate SEM photographs of using infrared rays for joining materials consisted of Ti-6Al-4V, 72Ag-28Cu and 17-4PH at 850 degrees centigrade for various processing time. Referring to FIGS. 6 and 7, as the processing temperature is increased or the heating time is prolonged, the thickness of a reaction layer defined between the metallic filler (72Ag-28Cu) and the base metal (T-6Al-4V) becomes thicker. During 30 sec of the heating time, the molten metallic filler cannot completely react with the base metal since the heating time is short. The Cu atoms of the metallic filler (72Ag-28Cu) react with Ti-6Al-4V but Ag atoms do not react with Ti-6Al-4V. Thus, there is a decrease of Cu content from the 72Ag-28Cu filler. As the heating time is increased, the original eutectic microstructure is changed into hypo-eutectic microstructure due to depletion of Cu content from the molten 72Ag-28Cu filler. Consequently, there exists a large scale of Ag-enriched phase in the joint as illustrated in FIGS. 7b and 7c.

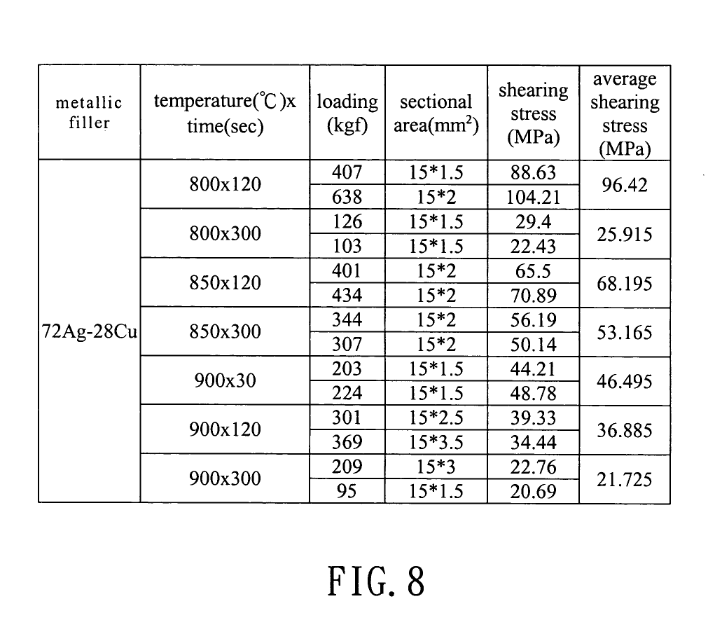

FIG. 8 illustrates an experimental data diagram of shear test for a joint consisted of Ti-6Al-4V, 72Ag-28Cu and 17-4PH in various processing conditions. The average maximum shear strength is about 96.4 MPa at 800 degrees centigrade of processing temperature for 120 sec of heating time. It can be found that the shear strength of the joint may has a trend of a decrease, as the processing temperature is increased or the heating time is prolonged. It is attributed that the growth of continuous reaction layer(s) in the interface causes the decrease of the shear strength of the joint. The result of the metallic fillers in this embodiment is similar to that of the pure silver. The better shear strength of thejoint may be obtained even if the processing temperature is low or the heating time is short. That is, using infrared rays for quick joining can suppress the interfacial reactions between the filler of 72Ag-28Cu and the base metal of Ti-6Al-4V, or between the filler of 72Ag-28Cu and the base metal of 17-4PH.

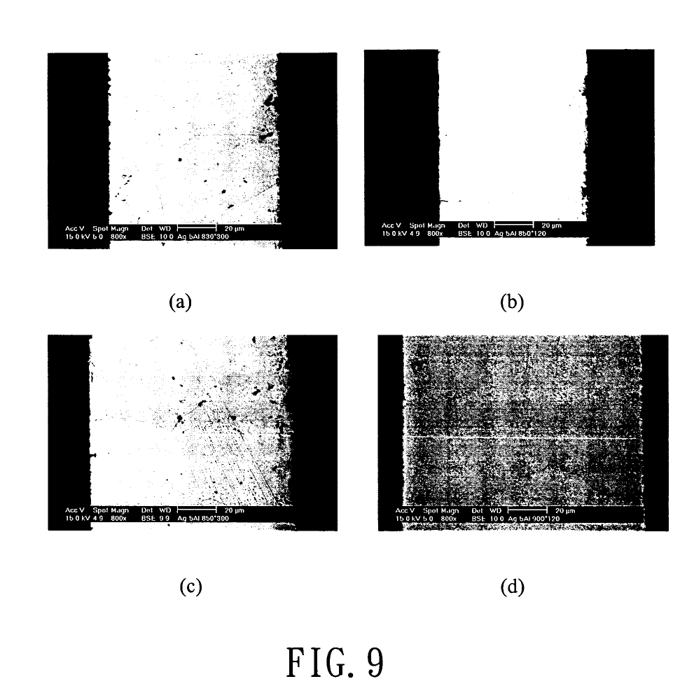

FIGS. 9a through 9d illustrate SEM photographs of using infrared rays for joining materials consisted of Ti-6Al-4V, 95Ag-5Al and 17-4PH at various degrees centigrade for a predetermined processing time. In FIGS. 9a through 9d, no continuous reaction layer has been identified in the joint between the metallic filler and the base metals. EPMA analysis for chemical composition cannot be processed accurately since the thickness of the reaction layer is less than 1 μm.

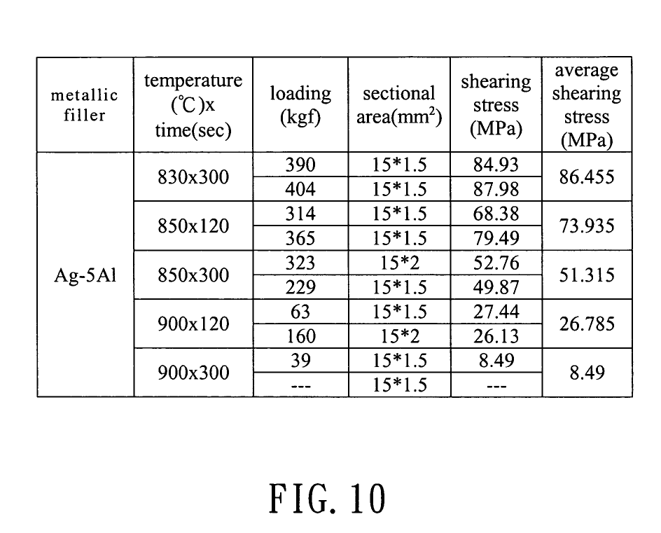

FIG. 10 illustrates an experimental data diagram of shear test for a joint consisted of Ti-6Al-4V, 95Ag-5A1 and 17-4PH in various processing conditions. The result of the metallic filler (95Ag-5A1) in this embodiment is similar to that of the pure silver. Using infrared rays for quick joining can suppress both the interfacial reaction as well as alloying effect between the filler and the base metals. The better strength of the joint may be obtained even if the processing temperature and/or time is decreased.

Using infrared rays for quick joining the golf club head is applied to suppress the growth of interfacial intermetallic compound(s) with brittleness to increase quality of products, manufacturing efficiency and utility rate of power. Therefore, infrared rays can be widely applied in joining the golf club head. It is anticipated that the product quality of the golf club head is greatly increased and the manufacture cost is significantly decreased.

Although the invention has been described in detail with reference to its presently preferred embodiment, it will be understood by one of ordinary skill in the art that various modifications can be made without departing from the spirit and the scope of the invention, as set forth in the appended claims.

1. Using infrared rays for quick joining a golf club head, comprising:
a heating source of infrared rays adapted to melt metallic filler disposed between golf club head members within a predetermined processing temperature and time, thereby joining the golf club head members to constitute the golf club head.

2. Using infrared rays for quick joining a golf club head as defined in claim 1, wherein either one or more of the golf club head members is selected from a main head body, a striking plate or a weight member.

3. Using infrared rays for quick joining a golf club head as defined in claim 1, wherein the golf club head member is selected from a group consisted of titanium alloy, Fe-base alloy, magnesium alloy, aluminum alloy, Fe—Mn—Al alloy, shape memory steel, tungsten alloy, copper alloy, lead alloy, nickel alloy, bulk amorphous alloy, nano-alloy, composite material and ceramic material etc.

4. Using infrared rays for quick joining a golf club head as defined in claim 1, wherein the heating source has a heating rate not less than 1° C./sec.

5. Using infrared rays for quick joining a golf club head as defined in claim 1, wherein the heating source has a heating rate up to 50° C./sec.

6. Using infrared rays for quick joining a golf club head as defined in claim 1, wherein the wavelength of infrared rays is ranging between 0.76 and 1,000 μm.

7. Using infrared rays for quick joining a golf club head as defined in claim 1, wherein the golf club head members are made of dissimilar categories of alloys.

8. Using infrared rays for quick joining a golf club head as defined in claim 1, wherein the golf club head members are made of similar categories of alloy.

9. Using infrared rays for quick joining a golf club head as defined in claim 1, wherein the golf club head members are placed in vacuum for joining process.

10. Using infrared rays for quick joining a golf club head as defined in claim 1, wherein the golf club head members are placed in protective gas for joining process.

11. Using infrared beam for quick-welding a golf club head as defined in claim 1, wherein the metallic filler is selected from a group consisted of Ag-base, Cu-base, Ni-base and Ti-base alloys etc.
